(19) United States
(12) Patent Application Publication
(10) Pub. No.: US 2017/0125990 A1
(43) Pub. Date: May 4, 2017

(54) ELECTRICAL JUNCTION BOX COVER DEVICE

(71) Applicant: AMDEV INTERNATIONAL, LLC, Naples, FL (US)

(72) Inventors: Roy SMITH, Naples, FL (US); Joti PROJKOVSKI, Naples, FL (US)

(21) Appl. No.: 15/335,031

(22) Filed: Oct. 26, 2016

Related U.S. Application Data
(60) Provisional application No. 62/248,499, filed on Oct. 30, 2015.

(51) Int. Cl. H02G 3/08; F21V 23/04

(52) U.S. Cl. CPC H02G 3/081; F21V 23/04; F21Y 2115/10

(57) ABSTRACT

An electrical junction box cover device for use with a plurality of remotely located switches includes a plate, first light, second light, first switch electrical input power source, first electrical neutral, second switch electrical input power source, and second electrical neutral. The plate has a front side and a back side. The first and second lights are positioned to direct light outward from the front side of the plate. The first switch electrical input power source is connected to an electrical input of the first light. The first electrical neutral is connected to an electrical output of the first light. The second switch electrical input power source is connected to an electrical input of the second light. The second electrical neutral is connected to an electrical output of the second light.

### CROSS-REFERENCE TO RELATED APPLICATIONS

This application claims the benefit of U.S. provisional application No. 62/248,499 filed on Oct. 30, 2015, the disclosure of which is hereby incorporated in its entirety by reference herein.

### TECHNICAL FIELD

The present disclosure relates to electrical systems and devices that may be utilized in electrical systems.

### BACKGROUND

Electrical systems may include junction boxes that include electrical connections to a power source. The electrical connections may be used to supply power to electrically operated devices, including electrical fixtures (e.g., lighting fixtures, fans, outlets, switches, etc.).

### SUMMARY

An electrical junction box cover device for use with a plurality of remotely located switches includes a plate, first light source, second light source, first switch electrical input power source, first electrical neutral, second switch electrical input power source, and second electrical neutral. The plate defines first and second orifices extending therethrough. The first and second light sources are disposed about the first and second orifices such that light is directed through the first and second orifices, respectively. Each light source is connected to an input electrical terminal and an output electrical terminal. The first switch electrical input power source is connected to the input electrical terminal of the first light source. The first electrical neutral is connected to the output electrical terminal of the first light source. The second switch electrical input power source is connected to the input electrical terminal of the second light source. The second electrical neutral is connected to the output electrical terminal of the second light source.

An electrical junction box cover device for use with a plurality of remotely located switches includes a plate, first light source, second light source, and a circuit board. The plate has a front side and a back side. The first and second light sources are positioned to direct light outward from the front side of the plate. The circuit board is secured to the back side of the plate. The circuit board has circuitry that connects the first light source to a first switch electrical input power source, connects the second light source to a second switch electrical input power source, and connects the first and second light sources to an electrical neutral.

An electrical junction box cover device for use with a plurality of remotely located switches includes a plate, first light, second light, first switch electrical input power source, first electrical neutral, second switch electrical input power source, and second electrical neutral. The plate has a front side and a back side. The first and second lights are positioned to direct light outward from the front side of the plate. The first switch electrical input power source is connected to an electrical input of the first light. The first electrical neutral is connected to an electrical output of the first light. The second switch electrical input power source is connected to an electrical input of the second light. The second electrical neutral is connected to an electrical output of the second light.

### BRIEF DESCRIPTION OF THE DRAWINGS

FIG. 1 is a perspective exploded view of an electrical junction box cover device;

FIG. 2 is a perspective view of the front side of the electrical junction box cover device;

FIG. 3 is a perspective view of the back side of the electrical junction box cover device;

FIG. 4 is an exemplary circuit board that may be utilized by the electrical junction box cover device; and

FIG. 5 is an exemplary electrical system that may include the electrical junction box cover device.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

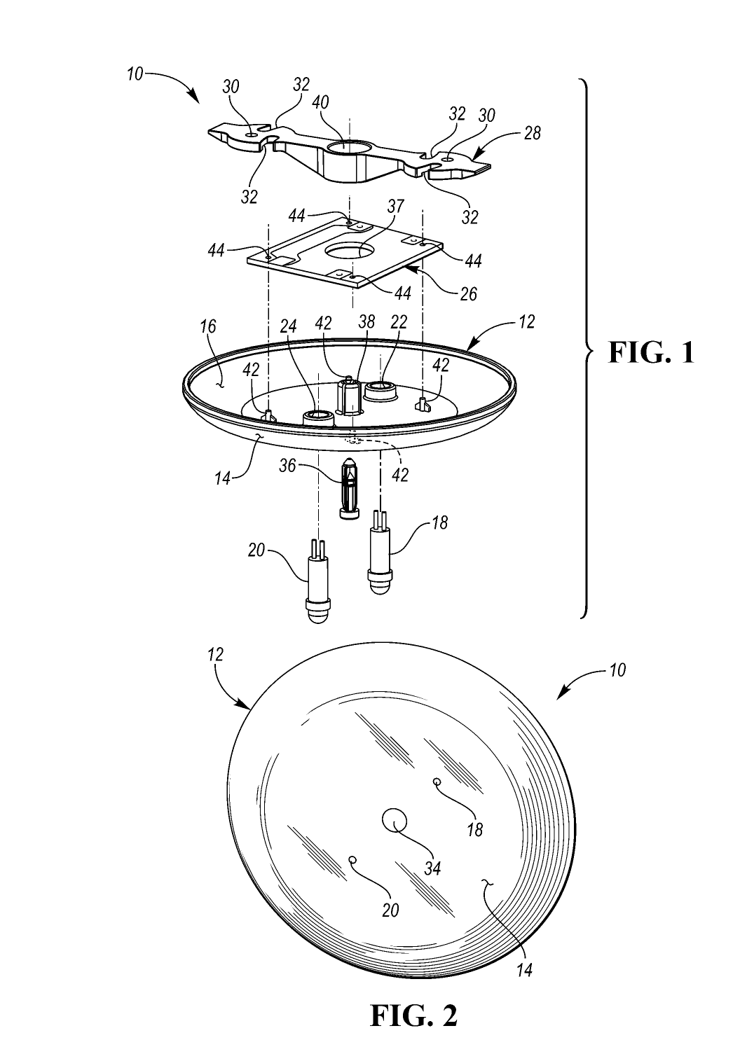

Referring to FIGS. 1-3, an electrical junction box cover device 10 is illustrated. The electrical junction box cover device 10 may be secured to an electrical junction box in order to cover and secure the internal contents of the electrical junction box, such as electrical power sources including hot electrical wires, located within the electrical junction box. The electrical junction box cover device 10 may be used with or work in conjunction with a plurality of switches. The plurality of switches may be remotely located relative to the cover device 10 and the junction box that the cover device 10 is secured to. For example, the switches may be located in second and third junction boxes that are separate and distinct from the junction box that the cover device 10 is secured to. The electrical junction box cover device 10 may include a plate (or cover plate) 12 that includes a front side 14 and a back side 16. A first light source 18 and a second light source 20 may be positioned on the plate 12, or in a location relative to the plate 12, such that light produced from the first light source 18 and the second light source 20 is directed outward from the front side 14 of the plate 12. The first light source 18 and the second light source 20 may be any type of light source including light emitting diodes (LEDs), incandescent bulbs, fluorescent bulbs, or any other type of light source know to a person on ordinary skill in the art. Furthermore, the plate 12 may define a first orifice 22 and a second orifice 24 extending therethrough. The first light source 18 and the second light source 20 may be disposed within or about the first orifice 22 and second orifice 24 such that light is directed through the first orifice 22 and second orifice 24, respectively.

The electrical junction box cover device 10 may also include a circuit board 26 that interacts with electrical power sources, the first light source 18, and the second light source 20 in order to provide electrical power to the first light source 18 and the second light source 20. The first light source 18 and the second light source 20 may be light sources that plug into the circuit board 26 or alternatively may be light sources, such as LEDs, that are disposed directly on the circuit board 26. The electrical junction box cover device 10 may also include a junction box mounting bracket 28 that is configured to secure the junction box cover device 10 to an electrical junction box. The junction box mounting bracket 28 may include mounting holes 30 and/or slots 32 that interact with fasteners to secure the junction box mounting bracket 28 to an electrical junction box. The fasteners may pass through the mounting holes 30 (which may be through holes) and/or the slots 32 and threaded into tapped holes defined by an electrical junction box. The plate 12 may define a fastener orifice 34 that is configured to receive a fastener 36 in order to secure the plate 12 to the junction box mounting bracket 28. The circuit board 26 may be disposed between the back side 16 of the plate 12 and the junction box mounting bracket 28. The circuit board 26 may be secured in the location between the back side 16 of the plate and the junction box mounting bracket 28 when the fastener 36 extends through the fastener orifice 34, through a hole 37 defined in the circuit board 26, and into the junction box mounting bracket 28.

The fastener 36 may be a locking pin that displaces a series of tabs or prongs 38 located on the back side 16 of the plate 12. The prongs 38 in turn expand outward and engage surfaces adjacent to an orifice 40 defined by the junction box mounting bracket 28 in order to secure the plate 12 to the junction box mounting bracket 28. The prongs 38 may also engage surfaces adjacent to the hole 37 defined in the circuit board 26 in order to secure the position of the circuit board 26 between the back side 16 of the plate 12 and the junction box mounting bracket 28. Alternatively, the fastener 36 may any type of fastening device or fastener known by a person of ordinary skill in the art include bolts, nails, rivets, etc. For example, a countersunk portion may be located on the back side 16 of the plate 12 where the prongs 38 are currently located, the fastener 36 may be disposed within a countersunk hole in the countersunk portion of the plate, and the fastener 36 may include threads that engage a tapped hole in the junction box mounting bracket 28 in order to secure the plate 12 to the junction box mounting bracket 28.

Fastening devices 42 may extend from the back side 16 of the plate 12. The fastening devices 42 may engage a plurality of holes 44 defined by the circuit board 26 in order to secure the circuit board 26 to the back side 16 of the plate 12. The fastening devices 42 may be rivets that are inserted into the plurality of holes 44 which are then deformed to secure the placement of the circuit board 26 relative to the plate 12. Alternatively, the circuit board 26 may be secured to the back side 16 of the plate 12 by other types of fasteners. For example, nails extending into the plate 12 or bolts engaging tapped holes in the plate 12 may be used to secure the position of the circuit board 26 relative to the plate 12.

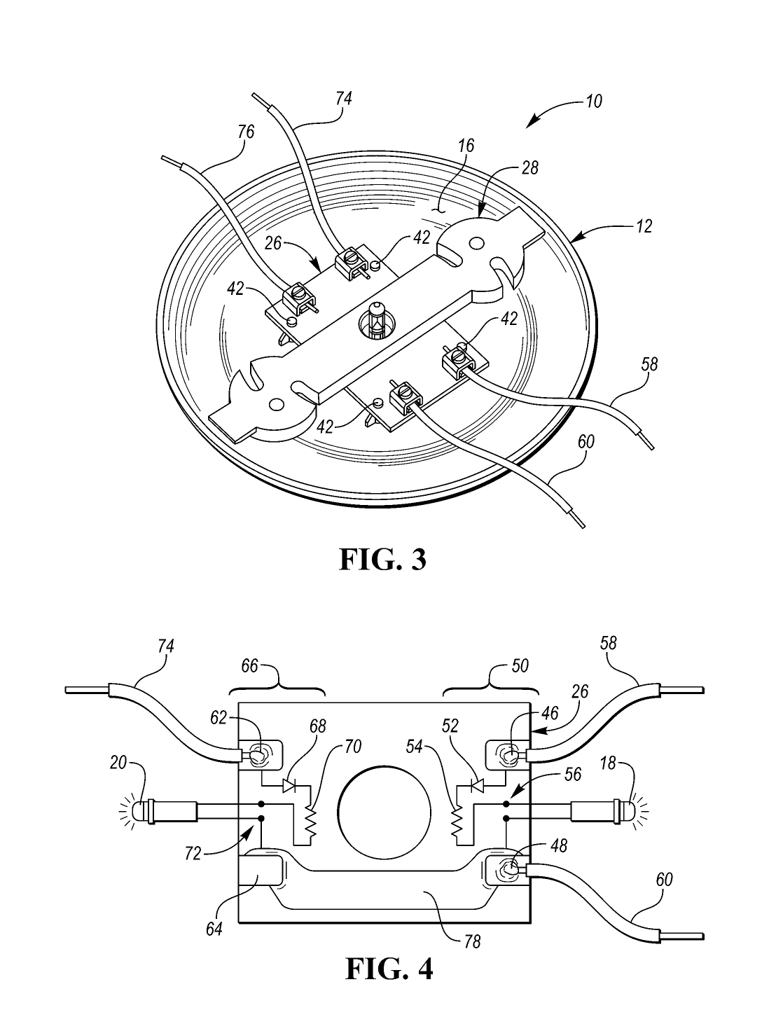

Referring to FIGS. 3 and 4, the circuit board 26 and the electrical connections that may be utilized to connect the first light source 18 and the second light source 20 to remotely located switches are illustrated. The first light source 18 is connected to a first input electrical terminal 46 and a first output electrical terminal 48. The first light source 18 may be directly connected to the first input electrical terminal 46 and first output electrical terminal 48. Alternatively, the first light source 18 may be connected to the first input electrical terminal 46 and first output electrical terminal 48 by a first circuit 50 disposed on the circuit board 26. The first circuit 50 may extend from the first input electrical terminal 46 to the first output electrical terminal 48. The first circuit may include a first diode 52, a first voltage reducing resistor 54, and a first connecting port 56 for the first light source 18. A first switch electrical input power source 58 may be connected to the first input electrical terminal 46. The first switch electrical input power source 58 may be connectable to or connected to a remotely located switch. The first switch electrical input power source 58 may be a hot wire or a separate wire that is connectable to a hot wire. A first electrical neutral 60 may be connected to the first output electrical terminal 48. The first electrical neutral 60 may be a neutral or ground wire, or a separate wire that is connectable to a neutral or ground wire. The first switch electrical input power source 58 may be connected to the first input electrical terminal 46 and the first electrical neutral 60 may be connected to the first output electrical terminal 48 by any method known by a person of ordinary skill in the art. For, example the connections between the wires and terminals depicted in FIG. 3 illustrate fasteners that connect the wires to the terminals while the connections between the wires and terminals depicted in FIG. 4 illustrate soldered connections.

The second light source 20 is connected to a second input electrical terminal 62 and a second output electrical terminal 64. The second light source 20 may be directly connected to the second input electrical terminal 62 and second output electrical terminal 64. Alternatively, the second light source 20 may be connected to the second input electrical terminal 62 and second output electrical terminal 64 by a second circuit 66 disposed on the circuit board 26. The second circuit 66 may extend from the second input electrical terminal 62 to the second output electrical terminal 64. The second circuit may include a second diode 68, a second voltage reducing resistor 70, and a second connecting port 72 for the second light source 20. A second switch electrical input power source 74 may be connected to the second input electrical terminal 62. The second switch electrical input power source 74 may be connectable to or connected to a remotely located switch. The second switch electrical input power source 74 may be a hot wire or a separate wire that is connectable to a hot wire. A second electrical neutral 76 may be connected to the second output electrical terminal 64. The second electrical neutral 76 may be a neutral or ground wire, or a separate wire that is connectable to a neutral or ground wire. The second switch electrical input power source 74 may be connected to the second input electrical terminal 62 and the second electrical neutral 76 may be connected to the second output electrical terminal 64 by any method known by a person of ordinary skill in the art. For, example the connections between the wires and terminals depicted in FIG. 3 illustrate fasteners that connect the wires to the terminals while the connections between the wires and terminals depicted in FIG. 4 illustrate soldered connections.

The circuitry of the circuit board 26, that includes the first circuit 50 and the second circuit 66, may include a common electrical terminal 78 that connects the first output electrical terminal 48 and the second output electrical terminal 64. Therefore, the first electrical neutral 60 may be connected to the second electrical neutral 76 by the common electrical terminal 78. Furthermore, one of the first electrical neutral 60 or the second electrical neutral 76 may be eliminated when there is a common connected between the first output electrical terminal 48 and the second output electrical terminal 64. For example, the second electrical neutral 76 has been eliminated in FIG. 4.

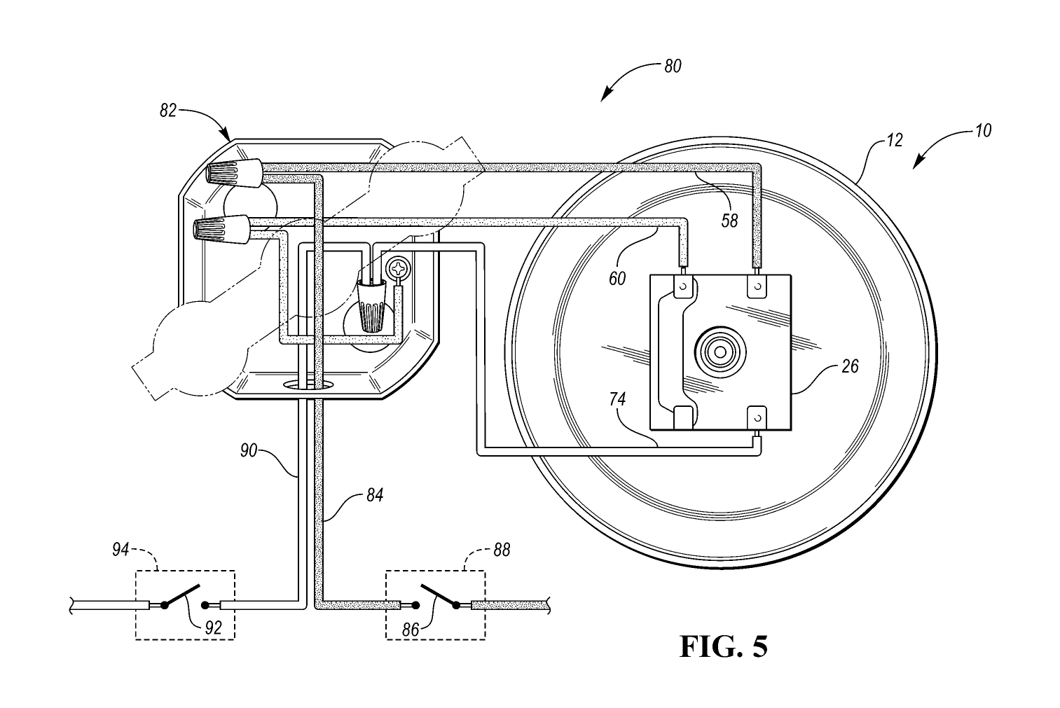

Referring to FIG. 5, an exemplary electrical system 80 that includes the electrical junction box cover device 10 and a first junction box 82, that the electrical junction box cover device 10 is secured to, are illustrated. The junction box mounting bracket 28 is shown to be secured to the first junction box 82 by at least one fastener. For illustrative purposes the plate 12, including the circuit board 26, are turned upside down and not yet connected to the junction box mounting bracket 28 to illustrate the electrical connections between the junction box and the components of the junction box cover device 10.

The first switch electrical input power source 58 is connected to a first hot wire 84 that extends to a first remotely located switch 86. When connected to the first switch electrical input power source 58, the first remotely located switch 86 may be configured to turn the first light source 18 on and off. The first switch electrical input power source 58 may be connected to the first hot wire 84 by a wire nut located within the first junction box 82. The first remotely located switch 86 may be located within a second junction box 88 that is separate and distinct from the first junction box 82. The second switch electrical input power source 74 is connected to a second hot wire 90 that extends to a second remotely located switch 92. When connected to the second switch electrical input power source 74, the second remotely located switch 92 may be configured to turn the second light source 20 on and off. The second switch electrical input power source 74 may be connected to the second hot wire 90 by a wire nut located within the first junction box 82. The second remotely located switch 92 may be located within a third junction box 94 that is separate and distinct from the first junction box 82. The first electrical neutral 60 and/or the second electrical neutral 76 may connected to one or more neutral wires that return to a main electrical panel or may be connected to one or more ground wires. The first electrical neutral 60 and/or the second electrical neutral 76 may connected to the neutral wires that return to a main electrical panel or the ground wires by wire nuts located within the first junction box 82.

The second junction box 88 and third junction box 94 may be separate and distinct from each other or may comprise the same junction box. The second junction box 88 and third junction box 94 may be similar in structure to the first junction box 82. The first junction box 82 may be useful for connecting electrical fixtures that include multiple electric devices where it may be desirable to operate the multiple electric devices separately. For example, it may be desirable to connect an electrical fixture that includes a light source and a fan to the first junction box 82 with the first remotely located switch 86 being configured to turn the light on and off and the second remotely located switch 92 being configured to turn the fan on and off. Furthermore, the first junction box 82 (with the light source and fan connected) may be located on the ceiling of a room while the second junction box 88 (including the first remotely located switch 86) and third junction box 94 (including the second remotely located switch 92) are located on the same or separate walls of the same room.

The electrical junction box cover device 10 should not be limited to the images depicted in FIGS. 1-5. For examples, the plate 12 may comprise any desirable shape required to adequately cover and secure the internal contents of an electrical junction box. The shape of the plate 12 may be adapted to the shape of the specific junction box that the electrical junction box cover device 10 is attached to. Furthermore, the disclosure should not be construed as limited to an electrical junction box cover device 10 having two light sources that interact with two remotely located switches, but should be construed to include all electrical junction box cover devices 10 that have two or more light sources that interact with two or more remotely located switches, where the remotely located switches may be any type of switch including 2-way switches, 3-way switches, 4-way switches, etc.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An electrical junction box cover device for use with a plurality of remotely located switches comprising:
a plate defining first and second orifices extending therethrough;
first and second light sources disposed about the first and second orifices such that light is directed through the first and second orifices, respectively, each light source connected to input and output electrical terminals;
a first switch electrical input power source connected to the input electrical terminal of the first light source;
a first electrical neutral connected to the output electrical terminal of the first light source;
a second switch electrical input power source connected to the input electrical terminal of the second light source; and
a second electrical neutral connected to the output electrical terminal of the second light source.

2. The electrical junction box cover device of claim 1 further comprising a circuit board having circuitry that connects the input and output electrical terminals of the first light source to the first light source and connects the input and output electrical terminals of the second light source to the second light source.

3. The electrical junction box cover device of claim 2 further comprising a junction box mounting bracket that is configured to secure the junction box cover device to an electrical junction box and wherein the circuit board is disposed between a back side of the plate and the mounting bracket.

4. The electrical junction box cover device of claim 3, wherein the plate defines a fastener orifice configured to receive a fastener and the plate is secured to the mounting bracket by a fastener that extends through the fastener orifice, through the circuit board, and into the mounting bracket.

5. The electrical junction box cover device of claim 3, wherein fastening devices protrude from the back side of the plate and the circuit board is secured to the plate via the fastening devices.

6. The electrical junction box cover device of claim 3, wherein the fastening devices are rivets.

7. The electrical junction box cover device of claim 2, wherein the circuitry connects the output terminal of the first light source to the output terminal of the second light source.

8. An electrical junction box cover device for use with a plurality of remotely located switches comprising:
a plate having a front side and a back side;
first and second light sources positioned to direct light outward from the front side of the plate; and
a circuit board secured to the back side of the plate and having circuitry that connects,
the first light source to a first switch electrical input power source,
the second light source to a second switch electrical input power source, and
the first and second light sources to an electrical neutral.

9. The electrical junction box cover device of claim 8, wherein the plate defines first and second orifices extending therethrough and wherein the first and second light sources are disposed about the first and second orifices such that light is directed through the first and second orifices, respectively.

10. The electrical junction box cover device of claim 8 further comprising a junction box mounting bracket that is configured to secure the junction box cover device to an electrical junction box and wherein the circuit board is disposed between a back side of the plate and the mounting bracket.

11. The electrical junction box cover device of claim 10, wherein the plate defines a fastener orifice configured to receive a fastener and the plate is secured to the mounting bracket by a fastener that extends through the fastener orifice, through the circuit board, and into the mounting bracket.

12. The electrical junction box cover device of claim 10, wherein fastening devices protrude from the back side of the plate and the circuit board is secured to the plate via the fastening devices.

13. The electrical junction box cover device of claim 10, wherein the fastening devices are rivets.

14. An electrical junction box cover device for use with a plurality of remotely located switches comprising:
a plate having a front side and a back side;
first and second lights positioned to direct light outward from the front side of the plate;
a first switch electrical input power source connected to an electrical input of the first light;
a first electrical neutral connected to an electrical output of the first light;
a second switch electrical input power source connected to an electrical input of the second light; and
a second electrical neutral connected to an electrical output of the second light.

15. The electrical junction box cover device of claim 14 further comprising a circuit board having circuitry that connects the electrical input and the electrical output of the first light to the first light and connects the electrical input and the electrical output of the second light to the second light.

16. The electrical junction box cover device of claim 15 further comprising a junction box mounting bracket that is configured to secure the junction box cover device to an electrical junction box and wherein the circuit board is disposed between a back side of the plate and the mounting bracket.

17. The electrical junction box cover device of claim 16, wherein the plate defines a fastener orifice configured to receive a fastener and the plate is secured to the mounting bracket by a fastener that extends through the fastener orifice, through the circuit board, and into the mounting bracket.

18. The electrical junction box cover device of claim 16, wherein fastening devices protrude from the back side of the plate and the circuit board is secured to the plate via the fastening devices.

19. The electrical junction box cover device of claim 14, wherein the plate defines first and second orifices extending therethrough and wherein the first and second lights are disposed about the first and second orifices such that light is directed through the first and second orifices, respectively.

20. The electrical junction box cover device of claim 14, wherein the first electrical neutral and the second electrical neutral are connected by a common electrical terminal.
